(19) United States
(12) Patent Application Publication
(10) Pub. No.: US 2022/0385111 A1
(43) Pub. Date: Dec. 1, 2022

(54) HEATED GEAR WIRELESS CHARGING

(71) Applicant: MILWAUKEE ELECTRIC TOOL CORPORATION, Brookfield, WI (US)

(72) Inventors: Donald J. Truettner, Waukesha, WI (US); Timothy R. Obermann, Waukesha, WI (US)

(21) Appl. No.: 17/827,176

(22) Filed: May 27, 2022

Related U.S. Application Data
(60) Provisional application No. 63/194,273, filed on May 28, 2021.

(51) Int. Cl. H02J 50/40; H02J 7/00; H05B 3/34; A41D 13/005; A41D 1/00

(52) U.S. Cl. CPC H02J 50/40; H02J 7/0048; H05B 3/342; A41D 13/0051; A41D 1/002; H02J 50/10

(57) ABSTRACT

A wireless charging system for heated garments includes a garment body, a heater coupled to the garment body, a receiver coupled to the garment body and configured to wirelessly receive power, an energy storage element coupled to the garment body and configured to store charge provided to the receiver, a controller selectively providing power from the energy storage element to the heater, and a power supply including a transmitter configured to wirelessly provide power to the receiver when the transmitter is near the receiver.

### RELATED APPLICATIONS

This application claims the benefit of U.S. Provisional Patent Application No. 63/194,273, filed May 28, 2021, the entire content of which is hereby incorporated by reference.

### FIELD

Embodiments described herein relate to heated gear.

### SUMMARY

Heated gear requires power in order to produce heat for warming the person wearing the heated gear. In order to produce a desired level of heat in the heated gear, the power source for the heated gear needs to be charged to an appropriate level. Heated gear is powered by, for example, batteries or battery packs that must be physically removed and attached to a charger to be charged if they are rechargeable. Removing and charging the batteries or battery packs is inconvenient and not conducive to an on-the-go lifestyle. Therefore, there is a need for efficient and effortless charging of a power supply for heated gear. For example, for batteries or a battery pack within heated gear, it would be advantageous to wirelessly charge the batteries or battery pack. Wireless charging could be achieved using power transmitted from a power source that fits the on-the-go lifestyle of the wearer of the heated gear. Additionally, heated gear would benefit from additionally being able to wirelessly power other pieces of heated gear.

Embodiments described herein provide systems for wirelessly charging wearable gear. The system includes a garment body, a heater coupled to the garment body, a receiver coupled to the garment body and configured to wirelessly receive power, an energy storage element configured to store charge provided by the receiver, a controller selectively providing power from the energy storage element to the heater, and a power supply including a transmitter configured to wirelessly provide power to the receiver when the transmitter is near the receiver.

Embodiments described herein provide a heated garment. The heated garment includes a garment body, a heater coupled to the garment body, a receiver coupled to the garment body and configured to wirelessly receive power, an energy storage element coupled to the garment body and configured to store charge provided to the receiver, and a controller configured to selectively provide power from the energy storage element to the heater.

Embodiments described herein provide a heated garment. The heated garment includes a garment body, a heater coupled to the garment body, a receiver coupled to the garment body and configured to wirelessly receive power, an energy storage element coupled to the garment body and configured to store charge provided to the receiver, a transmitter coupled to the garment body and configured to wirelessly transmit power from the energy storage element to a device, and a controller. The controller is configured to selectively provide power from the energy storage element to the heater and selectively provide power from the energy storage element to the transmitter.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1A illustrates a heated garment in accordance with embodiments described herein.

FIG. 1B illustrates a power supply for wireless charging the heated garment of FIG. 1A in accordance with embodiments described herein.

FIG. 1C illustrates wireless charging elements for the heated garment of FIG. 1A in accordance with embodiments described herein.

FIG. 2 is a block control diagram of the heated garment of FIG. 1A in accordance with embodiments described herein.

FIG. 3 is a block diagram of a heating system of the heated garment of FIG. 1A in accordance with embodiments described herein.

FIG. 4 is a block diagram of a power transmission system of the heated garment of FIG. 1A in accordance with embodiments described herein.

FIG. 5 illustrates a heated garment in accordance with embodiments described herein.

FIG. 6 illustrates a power supply for wireless charging the heated garment of FIG. 5 in accordance with embodiments described herein.

FIG. 7 illustrates wireless charging elements for a heated garment in accordance with embodiments described herein.

FIG. 8A illustrates a heated garment in accordance with embodiments described herein.

FIG. 8B illustrates an external power device for wirelessly powering the heated garment of FIG. 8A in accordance with embodiments described herein.

FIG. 9 illustrates an AC power supply for wireless charging any one of the heated garments described herein in accordance with embodiments described herein.

FIG. 10A illustrates a heated garment in accordance with embodiments described herein.

FIG. 10B illustrates an external power device for wirelessly powering the heated garment of FIG. 10A in accordance with embodiments described herein.

FIG. 11A illustrates a heated garment in accordance with embodiments described herein.

FIG. 11B illustrates a head covering wirelessly powered by the heated garment of FIG. 11A in accordance with embodiments described herein.

FIG. 12A illustrates a heated glove in accordance with embodiments described herein.

FIG. 12B illustrates a flashlight wirelessly powered by the heated glove of FIG. 12A in accordance with embodiments described herein.

FIG. 13A illustrates a heated garment in accordance with embodiments described herein.

FIG. 13B illustrates a safety vest wirelessly powered by the heated garment of FIG. 13A in accordance with embodiments described herein.

FIG. 14A illustrates a heated garment in accordance with embodiments described herein.

FIG. 14B illustrates an external power device for wirelessly powering the heated garment of FIG. 14A in accordance with embodiments described herein.

FIG. 15 illustrates a power supply with a magnetic element for wirelessly charging any one of the heated garments described herein in accordance with embodiments described herein.

FIG. 16 illustrates a heated garment in accordance with embodiments described herein.

FIG. 17A illustrates a heated glove in accordance with embodiments described herein.

FIG. 17B illustrates a steering wheel for wirelessly powering the heated glove of FIG. 17A in accordance with embodiments described herein.

FIG. 18 illustrates a power transfer system between heated garments in accordance with embodiments described herein.

FIG. 19 illustrates a heated garment with lighting elements in accordance with embodiments described herein.

### DETAILED DESCRIPTION

Embodiments described herein relate to heated garments that are wirelessly charged or powered. The heated garments may be configured to receiver power and transmit power to other heated garments and/or devices.

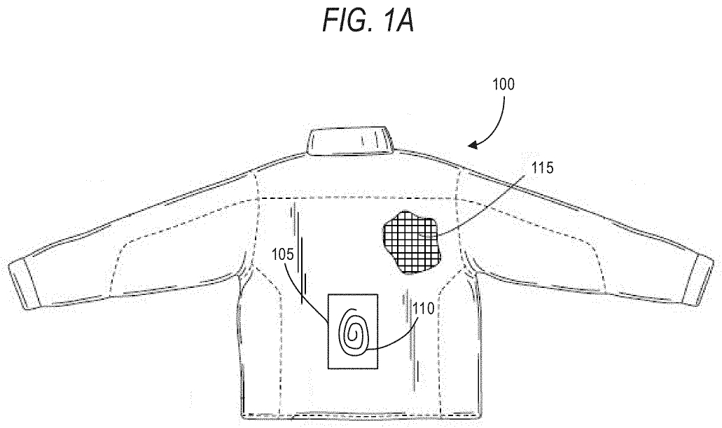

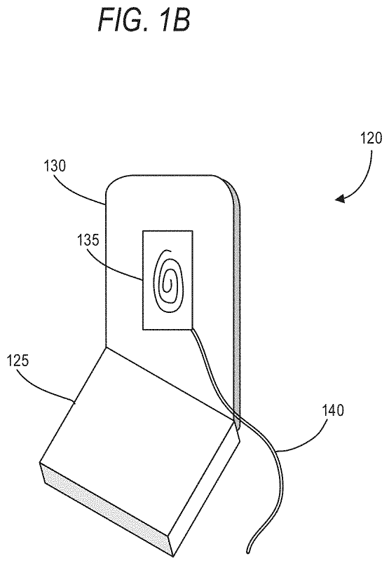

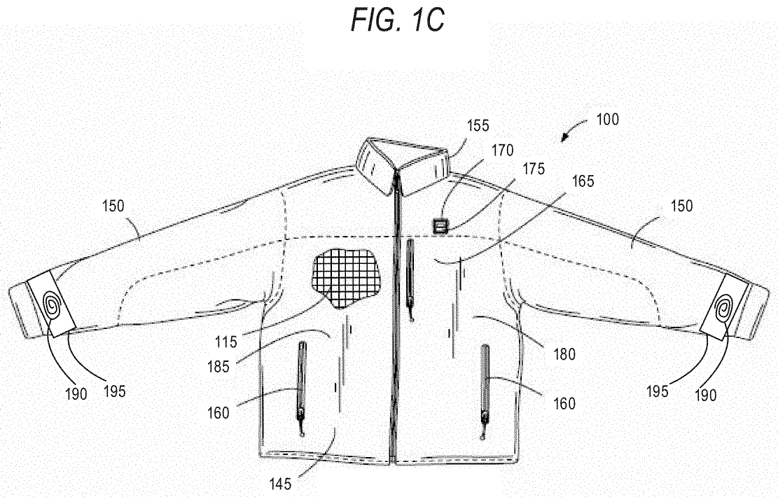

FIG. 1A illustrates an embodiment of a heated garment 100 that is wirelessly charged or powered. The heated garment 100 is configured to provide heat, via a heater or heater array 115, to a user wearing the heated garment 100. Heating a user wearing the heated garment 100 may also be referred to as the primary function of the heated garment 100. The particular heated garment 100 illustrated and provided herein (e.g., a heated jacket) is merely representative. Other embodiments may include a variety of garments. Garments can include, jackets, sweatshirts, hoodies, shirts, vests, pants, bibs, socks, shoes, gloves, hats, scarves, and the like.

The heated garment 100 illustrated in FIG. 1A shows a rear view of a heated jacket. The heated garment 100 includes a wireless receiver 105 and a receiving coil 110. As illustrated in a cutaway portion, the heated garment 100 also includes the heater array 115. The garment components of the heated garment 100 will be further described with respect to FIG. 1C. The wireless receiver 105 receives power from a power supply to charge one or more energy storage devices (e.g., battery packs, battery cells, capacitors, etc.) within or coupled to the heated garment 100. For example, the heated garment 100 may include a battery pack within the heated garment 100. For any references to a wireless power receiver or wireless power transmitter described herein, the receiver or transmitter could also be a transceiver that is capable of both wirelessly transmitting power and wirelessly receiving power.

The wireless receiver 105 may be located on the mid back side of the heated garment 100. However, other locations of the wireless receiver 105 are also contemplated. The wireless receiver 105 includes the receiving coil 110 that is configured to align with a transmitting coil of a power supply to allow for inductive and/or magnetic resonance power transfer via a magnetic field. As another example of wireless power transfer, the wireless receiver 105 may include a receiving antenna configured to allow for RF power transfer from a transmitting antenna of the power supply to the energy storage element of the heated garment 100.

The heater array 115 is located throughout the heated garment 100. In some embodiments, the heater array 115 may extend into the arms and/or the collar of the heated garment 100. The heater array 115 may be configured to generate heat based on a received DC voltage. For example, heat may be generated by voltage provided by the energy storage element. The heater array 115 may be a resistive heater array. However, other heater arrays are also contemplated. The heater array 115 may include resistive heating coils formed of carbon fibers, high density carbon fibers, or other heating devices. The heated garment 100 is capable of maintaining a temperature of up to 110 degrees Fahrenheit, although in other embodiments, lower or greater temperatures are possible depending upon the heat source or user selection (e.g., high, medium, low heat).

FIG. 1B illustrates an embodiment of a power supply 120 for wirelessly charging the energy storage element of the heated garment 100. The power supply 120 is configured to wirelessly provide power to the energy storage element of the heated garment 100 in order for the heated garment 100 to operate the heater array 115, among other things. The particular power supply 120 illustrated and provided (e.g., a car seat or car seat cover) herein is merely representative. Other embodiments include a variety of power supplies. Power supplies can include, garment hangers, mannequins, seat covers, and the like.

The power supply 120 illustrated in FIG. 1B is a car seat cover. In some embodiments, the car seat cover covers the seat back 130 of the car seat. Alternatively, or additionally, the car seat cover may cover the seat 125 of the car seat. The power supply 120 includes a wireless transmitter 135 and a power cord 140. In some embodiments, the power supply 120 is the same size as the wireless receiver 105.

The wireless transmitter 135 may be configured for capacitive power transfer, inductive power transfer, radio frequency (“RF”) power transfer, magnetic resonance power transfer, etc. For example, the wireless transmitter 135 may include one or more conductive plates configured to align with one or more conductive plates of the wireless receiver 105 of the heated garment 100 for capacitive power transfer via an electric field. As another example, the wireless transmitter 135 may include a transmitting coil configured to align with the receiving coil 110 of the wireless receiver 105 of the heated garment 100 to allow for inductive and/or magnetic resonance power transfer via a magnetic field. As another example of inductive power transfer, the wireless transmitter 135 may include a transmitting antenna configured to allow for RF power transfer to the wireless receiver 105 of the heated garment 100.

The power cord 140 is configured to be plugged into an outlet in order to power the wireless transmitter 135. For example, the power cord 140 may be plugged into a 12V DC outlet in a car. In some embodiments the power supply 120 may include a power converter to convert AC power into DC power useable by the wireless transmitter 135.

When configured for inductive power transfer, the wireless transmitter 135 and the wireless receiver 105 may each be constructed as a conductor wrapped into a coil shape or form (e.g., inductive coil). When provided with power and configured for inductive power transfer, the wireless transmitter 135 may be provided with an AC current that creates a cyclically changing magnetic field as the current cyclically changes (due to the cyclical nature of an AC signal). The changing magnetic field is transmitted through the air medium surrounding the wireless transmitter 135. The wireless receiver 105 of the heated garment 100 receives the changing magnetic field generated by the wireless transmitter 135. The changing magnetic field generated by the wireless transmitter 135 induces an AC signal in the wireless receiver 105 of the heated garment 100, which may then be rectified to a DC signal that is used to charge the energy storage element. In some embodiments, the inductive coil is formed by a coil trace on a printed circuit board (PCB), forming a PCB trace antenna. In some embodiments, the inductive coil or another wireless power transfer device 105, 135 includes a laser direct structuring (“LDS”) antenna that is built into the power supply 120 and/or the heated garment 100.

FIG. 1C illustrates an embodiment of wireless charging elements 195 for the heated garment 100. The wireless charging elements 195 are configured to provide power to heated gloves. The heated garment 100 of FIG. 1C is a front view of the heated garment 100 of FIG. 1A. The heated garment 100 includes typical garment features such as a torso body 145, arms 150, a collar 155, and front pockets 160. A front surface 165 of the heated garment 100 includes a control input. In the illustrated embodiment, the control input is a button 170 that may be actuated by a user. As explained in greater detail below, the button 170 includes a display portion 175 to indicate a status of the heated garment 100.

As illustrated in a cutaway portion, the heated garment 100 also includes the heater array 115. The heater array 115 is disposed in both a left portion 180 and a right portion 185 of the torso body 145. In some embodiments, the heater array 115 may extend into the arms 150 and/or collar 155. The heater array 115 may be configured to generate heat based on a received DC voltage. For example, the heater array 115 may be a resistive heater array. However, other heater array types are also contemplated. In other embodiments, the heated garment 100 may include a first heater array and second heater array arranged as an upper module and a lower module, respectively. In the illustrated embodiment, the heater array 115 is controlled via the button 170. In other embodiments, multiple heater arrays may be controlled individually via a single control input or multiple control inputs.

The wireless charging elements 195 include wireless transmitters 190. The wireless transmitters 190 may be configured for capacitive power transfer, inductive power transfer, radio frequency (“RF”) power transfer, magnetic resonance power transfer, etc. The wireless transmitters 190 transmit power from the energy storage element of the heated garment 100 to receivers within heated gloves, in order to power a heater array of the heated gloves. In some embodiments, the wireless transmitters 190 may transmit power to pants, socks, thermal tops, and the like.

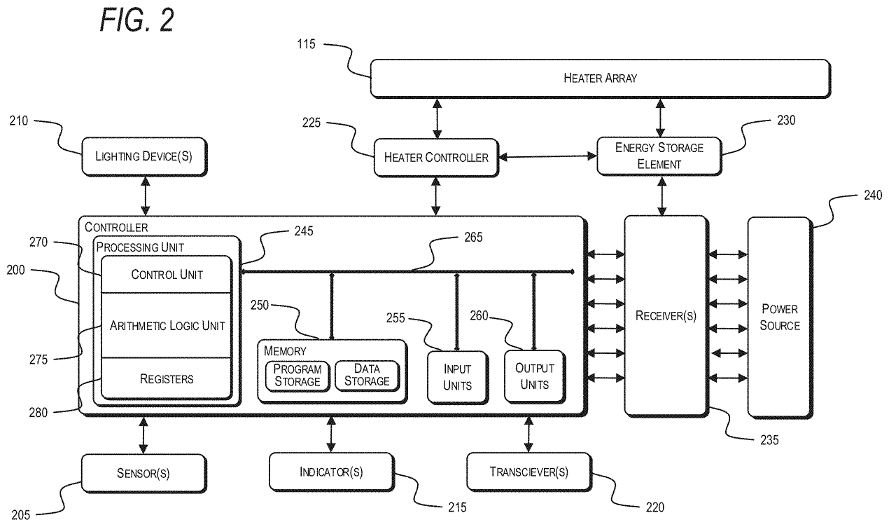

A controller 200 for the heated garment 100 is illustrated in FIG. 2. Although the controller 200 is specifically described with respect to the heated garment 100, the controller 200 can be included in any heated garment or device described herein even if specific reference is not made back to the controller 200 with respect to such heated garments or devices. The controller 200 is electrically and/or communicatively connected to a variety of modules or components of the heated garment 100. For example, the illustrated controller 200 is connected to sensors 204 (which may include temperature sensors), lighting devices 210, indicators 215, transceivers 220, a heater controller 225, and receivers 235.

The receivers 235 wirelessly receive power from a power source 240. The charging power received through the receivers 235 is provided to an energy storage element 230. For example, the energy storage element 230 may be a 12V battery pack, a capacitor, etc. The energy storage element 230 provides power to a heater array 115. The heater array 115 is controlled via the heater controller 225. In some embodiments, the heater controller 225 maintains the heater array at a temperature up to 110 degrees Fahrenheit, although in other embodiments, lower or greater temperatures are possible depending upon the heat source or user selection (e.g., high, medium, low heat).

The indicators 215 receive control signals from the controller 200 to turn ON and OFF or otherwise convey information based on different states of the heated garment 100. For example, the indicators 215 may display that the heater array 115 is ON, that the energy storage element 230 is out of power, the charge status of devices receiving charge via transceivers 220, etc. The indicators 215 include, for example, one or more light-emitting diodes (LEDs), or a display screen (e.g., an LCD display). The display/indicator(s) 215 may also include additional elements to convey information to a user through audible or tactile outputs (e.g., a speaker). The display/indicator(s) 215 may also be referred to as an output device configured to provide an output to a user.

The controller 200 includes a plurality of electrical and electronic components that provide power, operational control, and protection to the components and modules within the controller 200 and/or heated garment 100. For example, the controller 200 includes, among other things, a processing unit 245 (e.g., a microprocessor, an electronic processor, an electronic controller, a microcontroller, or another suitable programmable device), a memory 250, input units 255, and output units 260. The processing unit 245 includes, among other things, a control unit 270, an arithmetic logic unit (“ALU”) 275, and a plurality of registers 280 (shown as a group of registers in FIG. 2), and is implemented using a known computer architecture (e.g., a modified Harvard architecture, a von Neumann architecture, etc.). The processing unit 245, the memory 250, the input units 255, and the output units 260, as well as the various modules connected to the controller 200 are connected by one or more control and/or data buses (e.g., common bus 265). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 250 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 245 is connected to the memory 250 and executes software instruction that are capable of being stored in a RAM of the memory 250 (e.g., during execution), a ROM of the memory 250 (e.g., on a generally permanent basis), or another non-transitory computer readable medium such as another memory or a disc. Software included in the implementation of the heated garment 100 can be stored in the memory 250 of the controller 200. The software includes, for example, firmware, one or more applications, program data, filters, rules, one or more program modules, and other executable instructions. The controller 200 is configured to retrieve from the memory 250 and execute, among other things, instructions related to the control processes and methods described herein. In other embodiments, the controller 200 includes additional, fewer, or different components.

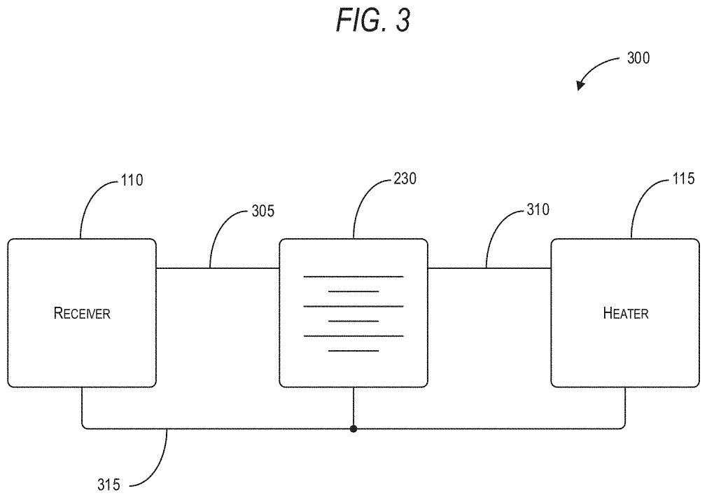

FIG. 3 illustrates a block diagram of a heating system 300 of the heated garment 100. The heating system includes the receiver 110, the energy storage element 230, and the heater 115. The receiver 110 transfers power from a power source to the energy storage element 230 via a first conductor 305. The energy storage element 230 stores the power received from the receiver 110 and uses the power to power the heater 115 via a second conductor 310. The receiver 110, the energy storage element 230, and the heater 115 are connected via a third conductor 315.

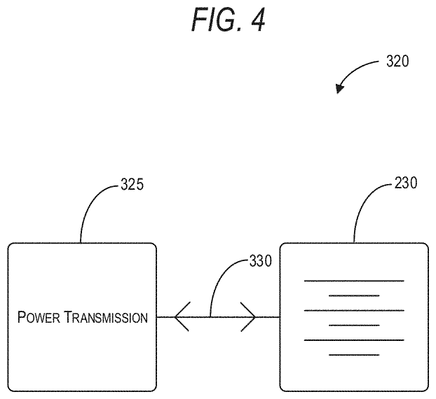

FIG. 4 illustrates a power transmission system 320 for the heated garment 100. A power transmission device 325 transmits power to and from the energy storage element 230 via a bidirectional conductor 330. The power transmission device 325 controls the amount of power being transmitted to the energy storage element 230. The energy storage element 230 may then regulate the flow of power to the heater 115.

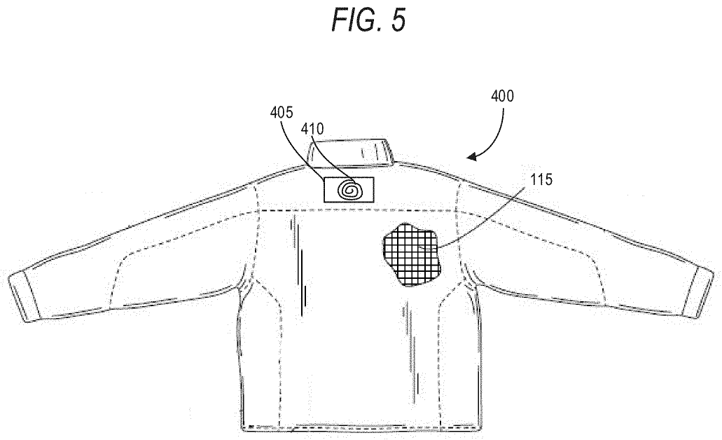

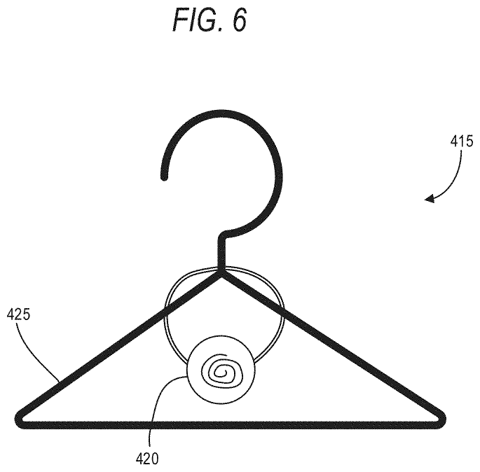

FIG. 5 illustrates an embodiment of a heated garment 400 that is wirelessly charged or powered. The heated garment 100 includes a wireless receiver 405 and a receiving coil 410. The wireless receiver 405 and the receiving coil 410 are located at a position on the heated garment 400 such that the wireless receiver may receive power from a power source when the heated garment 400 is hung up on a garment storage element, as further described with respect to FIG. 6. The received power is stored in an energy storage element. As illustrated in a cutaway portion, the heated garment 400 also includes the heater array 115. The heater array 115 is powered via power stored in the energy storage element or received by the wireless receiver 405.

FIG. 6 illustrates an embodiment of a power supply 415 for wirelessly charging the energy storage element of the heated garment 400. The particular power supply 415 illustrated and provided (e.g., a garment storage accessory) herein is merely representative. Other embodiments include a variety of accessories for garment storage. Garment storage accessories can include, garment hangers, mannequins, garment bags, and the like.

The power supply 415 illustrated in FIG. 6 is removably coupled to a garment hanger 425. The power supply 415 includes a wireless transmitter 420 that is hung on the garment hanger 425. In some embodiments, the wireless transmitter 420 is the same size as the wireless receiver 405. The wireless transmitter 420 may be configured for capacitive power transfer, inductive power transfer, radio frequency (“RF”) power transfer, magnetic resonance power transfer, etc. For example, the wireless transmitter 420 may include one or more conductive plates configured to align with one or more conductive plates of the wireless receiver 405 of the heated garment 400 for capacitive power transfer via an electric field. As another example, the wireless transmitter 420 may include a transmitting coil configured to align with the receiving coil 410 of the wireless receiver 405 of the heated garment 400 to allow for inductive and/or magnetic resonance power transfer via a magnetic field. As another example of inductive power transfer, the wireless transmitter 420 may include a transmitting antenna configured to allow for RF power transfer to the wireless receiver 405 of the heated garment 400.

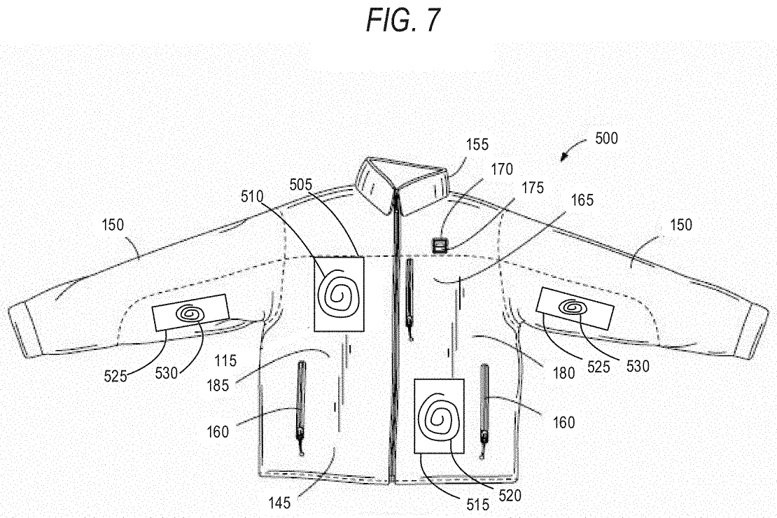

FIG. 7 illustrates an embodiment of a wirelessly charged or powered heated garment 500 that also wirelessly charges other devices. The heated garment 500 includes wireless charging elements 505, 515, 525 for wirelessly charging devices. The heated garment 500 of FIG. 7 includes similar garment features to the heated garment 100 of FIG. 1C, including a similar heater array and controller.

Wireless charging element 505 is configured to wirelessly charge a mobile device, for example, a cell phone. Wireless charging element 505 includes a wireless transmitter 510 configured for capacitive power transfer, inductive power transfer, radio frequency (“RF”) power transfer, magnetic resonance power transfer, etc. Wireless transmitter 510 transmits power from the energy storage element of the heated garment 500 to receiver(s) within the mobile device. In some embodiments, the heated garment 500 may include a pocket on the exterior of the torso body 145 that can hold the mobile device while it is being wirelessly charged by wireless charging element 505.

Similar to wireless charging element 505, wireless charging element 515 is configured to wirelessly charge another device, such as an audio listening device (e.g., a portable radio, wireless headphones, etc.). Wireless charging element 515 includes a wireless transmitter 520 configured for capacitive power transfer, inductive power transfer, radio frequency (“RF”) power transfer, magnetic resonance power transfer, etc. Wireless transmitter 520 transmits power from the energy storage element of the heated garment 500 to receiver(s) within the audio listening device. In some embodiments, the heated garment 500 may include a pocket on the exterior of the torso body 145 that can hold the audio listening device while it is being wirelessly charged by wireless charging element 515.

Wireless charging elements 525 are configured to wirelessly charge illumination devices, for example, flashlights, headlamps, etc. Wireless charging elements 525 include wireless transmitters 530 configured for capacitive power transfer, inductive power transfer, radio frequency (“RF”) power transfer, magnetic resonance power transfer, etc. Wireless transmitters 530 transmit power from the energy storage element of the heated garment 500 to receiver(s) within the illumination devices. In some embodiments, the heated garment 500 may include pockets on the exterior of the torso body 145 that can hold illumination devices while they are wirelessly charged by wireless charging element 525.

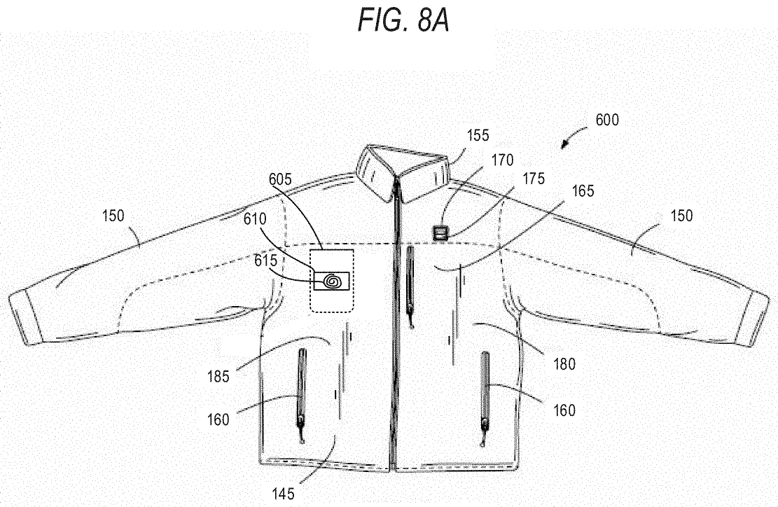

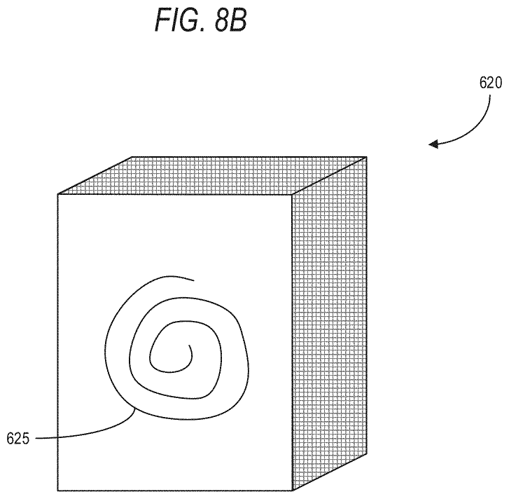

FIG. 8A illustrates an embodiment of a heated garment 600 that is wirelessly charged or powered. The heated garment 600 includes a pocket 605 with a wireless receiver 610 and a receiving coil 615. The wireless receiver 610 is configured to receive power from an external power device when the external power device is received by the pocket 605, as described further with respect to FIG. 8B. Additionally, the heated garment 600 includes similar garment features to the heated garment 100 of FIG. 1C, including a similar heater array and controller.

FIG. 8B illustrates an external power device 620 for wirelessly charging the energy storage element of the heated garment 600. The particular external power device 620 illustrated and provided (e.g., a power bank) herein is merely representative. Other embodiments include a variety of external power devices, such as battery packs. The external power device 620 is configured to be received within the pocket 605 of the heated garment 600 such that a wireless transmitter 625 of the external power device 620 is aligned with the receiver 610 of the heated garment 600. The wireless transmitter 625 may be configured for capacitive power transfer, inductive power transfer, radio frequency (“RF”) power transfer, magnetic resonance power transfer, etc. In some embodiments, rather than charging the energy storage element of the heated garment 600, the external power device wirelessly powers the heated garment 600 independent of the energy storage element of the heated garment.

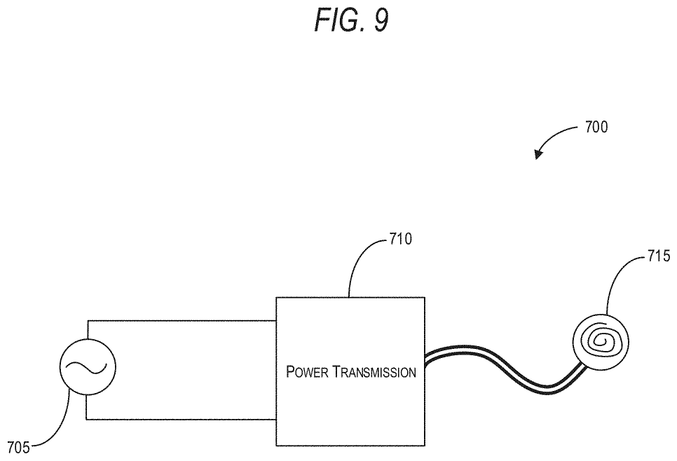

FIG. 9 illustrates an alternating current (AC) power supply 700 for wireless charging or preheating of a heated garment according to any one of the embodiments described herein. The preheating of the heated garment can be controlled so the heated garment is already warm when the heated garment is worn. In some embodiments, preheating can be performed without using power from the energy storage unit. In some embodiments, preheating can be controlled wirelessly from a smartphone (e.g., over a Bluetooth connection). The heated garment is configured to receive one or more control signals related to starting the heating process, ending the heating process, selecting a temperature for the heated garment etc. In some embodiments, the heating of the heated garment is controlled based on an ambient temperature associated with the heated garment (e.g., a temperature within a cabin of a vehicle).

The AC power supply includes an AC power source 705, a power transmission device 710, and a wireless transmitter 715. The AC power source 705 may be a power source that supplies single AC line voltage or universal AC line voltage such as a conventional wall outlet, a car outlet, etc. The power transmission device 710 may include an AC/DC converter that converts AC power into DC power that is usable by the wireless transmitter 715. Alternatively, the power transmission device 710 may transmit the AC power to the wireless transmitter 715, such that the magnetic field created by the wireless transmitter 715 is cyclical in nature.

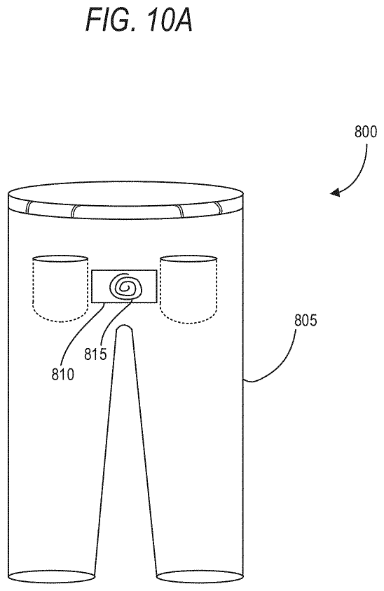

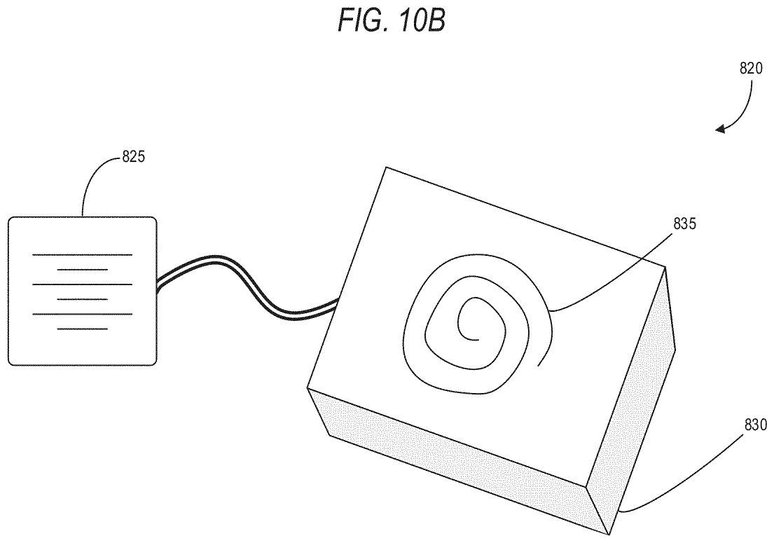

FIG. 10A illustrates an embodiment of a heated garment 800 that is wirelessly charged or powered. The particular heated garment 800 illustrated and provided herein (e.g., heated pants) is merely representative. Other embodiments may include a variety of garments. Garments can include, jackets, sweatshirts, hoodies, vests, pants, bibs, skirts, socks, shoes, gloves, hats, scarves, and the like.

The heated garment 800 illustrated in FIG. 10A is a rear view of heated pants 805. The heated garment 800 includes a wireless receiver 810 and a receiving coil 815. The heated garment 800 also includes a heater array, similar to the heater array 115 of FIG. 1A. The wireless receiver 810 receives power from a power supply to charge one or more energy storage devices within the heated garment 800. For example, the heated garment 800 may include a battery pack within the heated garment 800. In some embodiments, rather than charging the energy storage element of the heated garment 800, the external power supply powers the heated garment 800 independent of the energy storage element of the heated garment.

The wireless receiver 810 may be located in the seat portion of the heated garment 800. However, other locations of the wireless receiver 810 are also contemplated. The wireless receiver 810 includes the receiving coil 815 that is configured to align with a transmitting coil of a power supply to allow for inductive and/or magnetic resonance power transfer via a magnetic field. As another example of wireless power transfer, the wireless receiver 810 may include a receiving antenna configured to allow for RF power transfer from a transmitting antenna of the power supply to the energy storage element of the heated garment 800.

The heater array is disposed throughout the heated garment 800. In some embodiments, the heater array may extend into the legs of the heated garment 800. The heater array may be configured to generate heat based on a received DC voltage. For example, heat may be generated by voltage produced by the energy storage element. The heater array may be a resistive heater array. However, other heater arrays are also contemplated. The heater array may include resistive heating coils formed of carbon fibers, high density carbon fibers, or other heating devices. In some embodiments, the heated garment 800 is capable of maintaining a temperature of up to 110 degrees Fahrenheit, although in other embodiments, lower or greater temperatures are possible depending upon the heat source or user selection (e.g., high, medium, low heat).

FIG. 10B illustrates an illustrates an embodiment of a power supply 820 for wirelessly charging the energy storage element of the heated garment 800. The power supply 820 is configured to wirelessly provide power to the energy storage element of the heated garment 800 in order for the heated garment 800 to operate the heater array, among other things. The particular power supply 820 illustrated and provided (e.g., a seat cushion) herein is merely representative. Other embodiments include a variety of power supplies. Power supplies can include, garment hangers, mannequins, seat covers, and the like.

The power supply 820 illustrated in FIG. 10B is a seat cushion 830. In some embodiments, the seat cushion 830 is configured to be placed on a chair or other furniture so that when a person wearing the heated garment 800 is seated in the chair, power is being transferred from the seat cushion 830 to the heated garment 800. The power supply 820 includes a wireless transmitter 835 and a power device 825. In some embodiments, the power supply 820 is the same size as the wireless receiver 810.

The wireless transmitter 835 may be configured for capacitive power transfer, inductive power transfer, radio frequency (“RF”) power transfer, magnetic resonance power transfer, etc. For example, the wireless transmitter 835 may include one or more conductive plates configured to align with one or more conductive plates of the wireless receiver 810 of the heated garment 800 for capacitive power transfer via an electric field. As another example, the wireless transmitter 835 may include a transmitting coil configured to align with the receiving coil 815 of the wireless receiver 810 of the heated garment 800 to allow for inductive and/or magnetic resonance power transfer via a magnetic field. As another example of inductive power transfer, the wireless transmitter 835 may include a transmitting antenna configured to allow for RF power transfer to the wireless receiver 810 of the heated garment 800.

The power device 825 may be a battery pack, for example, a 12V battery pack, an 18V battery pack, etc. The power device 825 supplies power to the wireless transmitter 835. In some embodiments, the seat cushion 830 may be plugged into an outlet, such that AC power is supplied to the wireless transmitter 835.

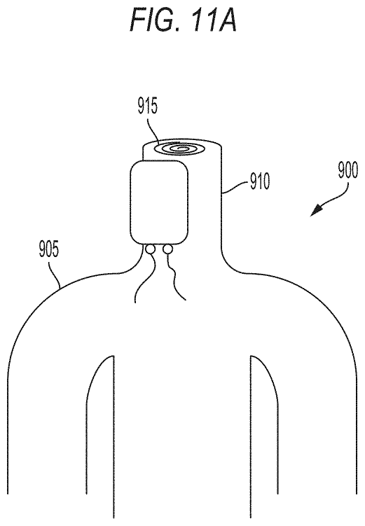

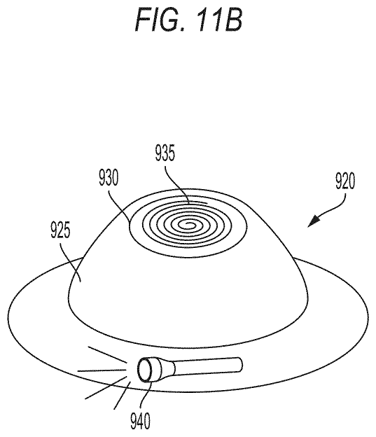

FIG. 11A illustrates an embodiment of a heated garment 900 that wirelessly transmits power. The particular heated garment 900 illustrated and provided herein (e.g., a heated hoodie) is merely representative. Other embodiments may include a variety of garments. Garments can include jackets with hoods, vests with hoods, an attachable hood, and the like.

The heated garment 900 illustrated in FIG. 11a is a heated hoodie. The heated hoodie includes a garment body part 905 and a hood 910. The heated garment 900 also includes a heater array, similar to the heater array 115 of FIG. 1A. On the top of the hood is a wireless transmitter 915. The wireless transmitter 915 is configured to transmit power from an energy storage element within the heated garment 900 to a head covering, as will be further described with respect to FIG. 11b. The wireless transmitter 835 may be configured for capacitive power transfer, inductive power transfer, radio frequency (“RF”) power transfer, magnetic resonance power transfer, etc.

FIG. 11B illustrates an embodiment of a head covering 920 wirelessly charged or powered by the heated garment 900. The particular head covering 920 illustrated and provided herein (e.g., a construction hat) is merely representative. Other embodiments may include a variety of head coverings. Head coverings can include, hats, headbands, head lamps, and the like. In some embodiments, the head covering 920 includes an energy storage element that can be wirelessly charged.

The head covering 920 illustrated in FIG. 11B is a construction hat 925. The head covering 920 includes a wireless receiver 930 and a receiving coil 935. The head covering 920 also includes an illumination member 940. The wireless receiver 930 receives power from the heated garment 900, via the wireless transmitter 915, to illuminate the illumination member 940. In some embodiments, the illumination member 940 is illuminated when the wireless receiver 930 is receiving power from the wireless transmitter 915. Additionally or alternatively, the head covering 920 may include a switch to selectively activate the illumination member 940.

The wireless receiver 930 may be located on a top portion of the head covering 920. However, other locations of the wireless receiver 930 are also contemplated. The wireless receiver 930 includes the receiving coil 935 that is configured to align with a transmitter 915 of the heated garment 900 to allow for inductive and/or magnetic resonance power transfer via a magnetic field. As another example of wireless power transfer, the wireless receiver 930 may include a receiving antenna configured to allow for RF power transfer from a transmitting antenna of the heated garment 900 to illumination member 940.

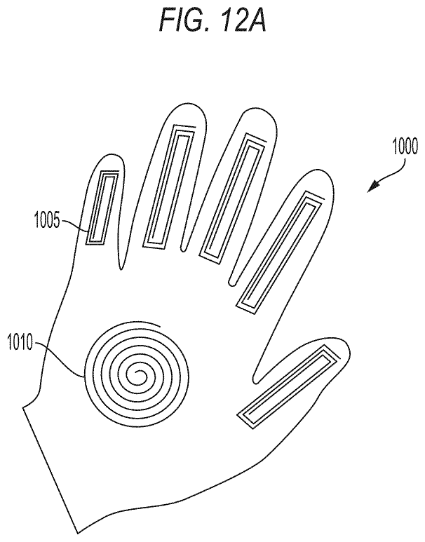

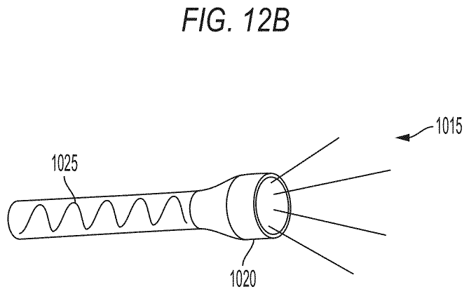

FIG. 12A illustrates an embodiment of a heated garment 1000 that wirelessly transmits or receives power. The particular heated garment 1000 illustrated and provided herein (e.g., a heated glove) is merely representative. Other embodiments may include a variety of garments. Garments can include, mittens, fingerless gloves, long sleeve shirts with thumb-holes, and the like. In some embodiments, the heated garment 1000 includes an energy storage element that can be wirelessly charged.

The heated garment 1000 includes a wireless transmitter or receiver (e.g., transceiver) 1010. As shown in the finger portions of the heated garment 1000, the heated garment 1000 also includes one or more heater arrays 1005. The heater array 1005 may be configured to generate heat based on a received DC voltage. For example, heat may be generated by voltage produced by an energy storage element within the heated garment 1000. Additionally or alternatively, heat may be generated by power wirelessly received from another heated garment, such as heated garment 100 of FIG. 1C. As such, in some embodiments, the heated garment 1000 may include a wireless receiver in addition to and separate from the transceiver 1010. The heater array 1005 may be a resistive heater array. However, other heater arrays are also contemplated. The heater array 1005 may include resistive heating coils formed of carbon fibers, high density carbon fibers, or other heating devices. In some embodiments, the heated garment 1000 is capable of maintaining a temperature of up to 110 degrees Fahrenheit, although in other embodiments, lower or greater temperatures are possible depending upon the heat source or user selection (e.g., high, medium, low heat).

The wireless transceiver 1010 may be configured to transmit power to a device when a person wearing the heated garment 1000 is holding the device. A device 1015 that is powered by power received from the heated garment 1000 is illustrated in FIG. 12B. The particular device 1015 illustrated and provided herein (e.g., a flashlight) is merely representative. Other embodiments may include a variety of devices. Devices can include, power tools, mobile phones, radios, beverage containers (e.g., coffee cup), and the like. In some embodiments, the device 1015 includes an energy storage element that can be wirelessly charged.

The device 1015 illustrated in FIG. 12B is a flashlight. The device 1015 includes a wireless receiver 1025 and a receiving coil. The device 1015 also includes an illumination part 1020. The wireless receiver 1025 directly and/or indirectly receives power from the heated garment 1000, via the wireless transceiver 1010, to power the illumination part 1020 of the device 1015. In some embodiments, the illumination part 1020 is illuminated when the wireless receiver 1025 is receiving power from the wireless transmitter 1010 of the heated garment 1000. Additionally or alternatively, the device 1015 may include a switch to selectively activate the illumination part 1020.

The wireless receiver 1025 may be located within the handle of the device 1015. However, other locations of the wireless receiver 1025 are also contemplated. The wireless receiver 1025 includes the receiving coil that is configured to align with a transmitting coil of the heated garment 1000 to allow for inductive and/or magnetic resonance power transfer via a magnetic field. As another example of wireless power transfer, the wireless receiver 1025 may include a receiving antenna configured to allow for RF power transfer from a transmitting antenna of the heated garment 1000 to the illumination part 1020.

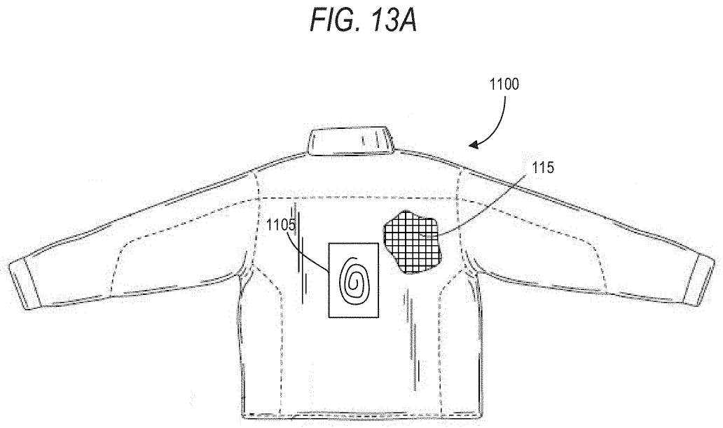

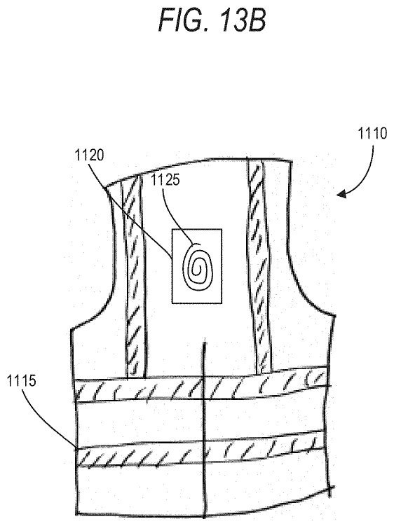

FIG. 13A illustrates an embodiment of a heated garment 1100 that wirelessly provides power to safety vest. The heated garment 1100 is configured to provide heat, via the heater array 115, to a user wearing the heated garment 1100. The particular heated garment 1100 illustrated and provided herein (e.g., a heated jacket) is merely representative. Other embodiments may include a variety of garments. Garments can include, jackets, sweatshirts, hoodies, vests, pants, bibs, socks, shoes, gloves, hats, scarves, and the like.

The heated garment 1100 illustrated in FIG. 13A is a rear view of a heated jacket. The heated garment 1100 includes a wireless transmitter 1105. The wireless transmitter 1105 transmits power from an energy storage element within the heated garment 1100. The wireless transmitter 1105 may be located on the mid back side of the heated garment 1100. However, other locations of the wireless transmitter 1105 are also contemplated.

The heater array 115 is disposed throughout the heated garment 1100. In some embodiments, the heater array 115 may extend into the arms and/or the collar of the heated garment 1100. The heater array 115 may be configured to generate heat based on a received DC voltage. For example, heat may be generated by voltage produced by the energy storage element. The heater array 115 may be a resistive heater array. However, other heater arrays are also contemplated. The heater array 115 may include resistive heating coils formed of carbon fibers, high density carbon fibers, or other heating devices. In some embodiments, the heated garment 1100 is capable of maintaining a temperature of up to 110 degrees Fahrenheit, although in other embodiments, lower or greater temperatures are possible depending upon the heat source or user selection (e.g., high, medium, low heat).

FIG. 13B illustrates an embodiment of a safety vest 1110 that wirelessly receives power from the energy storage element of the heated garment 1100. The particular safety vest 1110 illustrated and provided herein is merely representative. Other embodiments may include a variety of safety vests. In some embodiments, the safety vest 1110 includes an energy storage element that can be wirelessly charged.

The safety vest 1110 includes a wireless receiver 1120 and a receiving coil 1125. The safety vest 1110 also includes an illumination part 1115. The wireless receiver 1120 receives power from the heated garment 1100, via the wireless transmitter 1105, to illuminate the illumination part 1115 of the safety vest 1110. In some embodiments, the illumination part 1115 is illuminated when the wireless receiver 1120 is receiving power from the wireless transmitter 1105 of the heated garment 1100. Alternatively, or additionally, the safety vest 1110 may include a switch to selectively activate the illumination part 1115.

The wireless receiver 1120 may be located on the mid back of side of the safety vest 1110 such that when a person wears the safety vest 1110 over the heated garment 1100, the wireless receiver 1120 is aligned with the wireless transmitter 1105. However, other locations of the wireless receiver 1120 are also contemplated. The wireless receiver 1120 includes the receiving coil 1125 that is configured to align with a transmitting coil of the heated garment 1100 to allow for inductive and/or magnetic resonance power transfer via a magnetic field. As another example of wireless power transfer, the wireless receiver 1120 may include a receiving antenna configured to allow for RF power transfer from a transmitting antenna of the heated garment 1100 to the illumination part 1115.

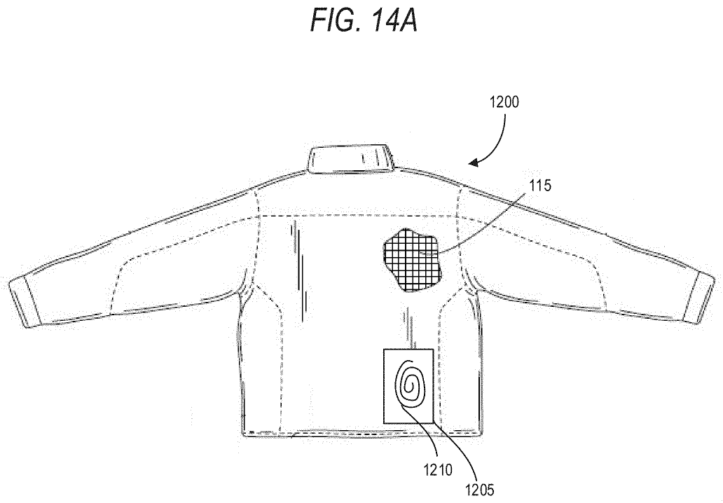

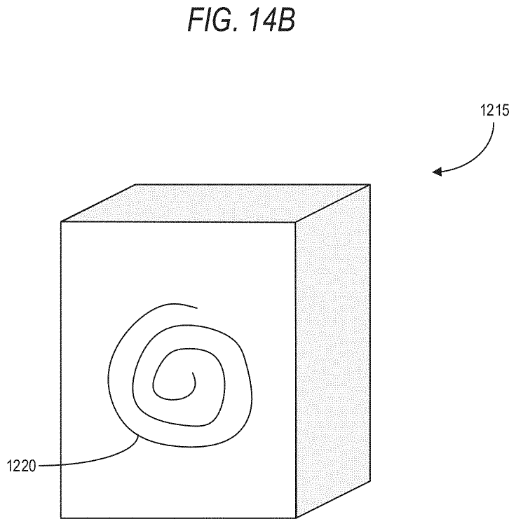

FIG. 14A illustrates an embodiment of a heated garment 1200 that is wirelessly charged or powered. The heated garment 1200 is configured to provide heat, via the heater array 115, to a user wearing the heated garment 1200. The particular heated garment 1200 illustrated and provided herein (e.g., a heated jacket) is merely representative. Other embodiments may include a variety of garments. Garments can include, jackets, sweatshirts, hoodies, vests, pants, bibs, socks, shoes, gloves, hats, scarves, and the like.

The heated garment 1200 illustrated in FIG. 14A is a rear view of a heated jacket. The heated garment 1200 includes a wireless receiver 1205 and a receiving coil 1210. As illustrated in a cutaway portion, the heated garment 1200 also includes a heater array 115. The wireless receiver 1205 receives power from an external power device to charge one or more energy storage devices within the heated garment 1200. For example, the heated garment 1200 may include a battery pack within the heated garment 1200.

The wireless receiver 1205 may be located on the lower back side of the heated garment 1200. However, other locations of the wireless receiver 1205 are also contemplated. The wireless receiver 1205 includes the receiving coil 1210 that is configured to align with a transmitting coil of an external power device to allow for inductive and/or magnetic resonance power transfer via a magnetic field. As another example of wireless power transfer, the wireless receiver 1205 may include a receiving antenna configured to allow for RF power transfer from a transmitting antenna of the power supply to the energy storage element of the heated garment 1200.

The heater array 115 is disposed throughout the heated garment 1200. In some embodiments, the heater array 115 may extend into the arms and/or the collar of the heated garment 1200. The heater array 115 may be configured to generate heat based on a received DC voltage. For example, heat may be generated by voltage produced by the energy storage element. The heater array 115 may be a resistive heater array. However, other heater arrays are also contemplated. The heater array 115 may include resistive heating coils formed of carbon fibers, high density carbon fibers, or other heating devices. In some embodiments, the heated garment 1200 is capable of maintaining a temperature of up to 110 degrees Fahrenheit, although in other embodiments, lower or greater temperatures are possible depending upon the heat source or user selection (e.g., high, medium, low heat).

FIG. 14B illustrates an embodiment of an external power device 1215 for wirelessly charging the energy storage element of the heated garment 1200. The external power device 1215 is configured to wirelessly provide power to the energy storage element of the heated garment 1200 in order for the heated garment 1200 to operate the heater array 115, among other things. The particular external power device 1215 illustrated and provided is a removable and rechargeable battery pack (e.g., an 18V battery pack) and is merely representative. Other embodiments include a variety of battery packs. Battery packs may be 4V, 12V, etc.

The external power device 1215 illustrated in FIG. 14B includes a wireless transmitter 1220. In some embodiments, the external power device 1215 is the same size as the wireless receiver 1205. The wireless transmitter 1220 may be configured for capacitive power transfer, inductive power transfer, radio frequency (“RF”) power transfer, magnetic resonance power transfer, etc. For example, the wireless transmitter 1220 may include one or more conductive plates configured to align with one or more conductive plates of the wireless receiver 1205 of the heated garment 1200 for capacitive power transfer via an electric field. As another example, the wireless transmitter 1220 may include a transmitting coil configured to align with the receiving coil 1210 of the wireless receiver 1205 of the heated garment 1200 to allow for inductive and/or magnetic resonance power transfer via a magnetic field. As another example of inductive power transfer, the wireless transmitter 1220 may include a transmitting antenna configured to allow for RF power transfer to the wireless receiver 1205 of the heated garment 1200.

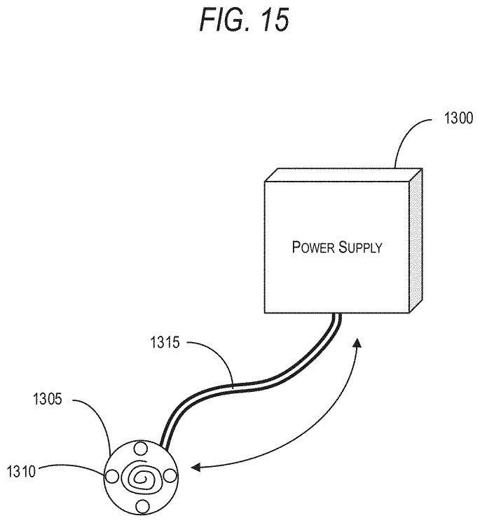

FIG. 15 illustrates a power supply 1300 with one or more magnetic elements 1310 for wirelessly charging of a heated garment according to any one of the embodiments described herein. The power supply 1300 includes the magnetic elements 1310 with a wireless transmitter 1305 that is moveable in open space via a retractable cord 1315. The power supply 1300 may be a wall mounted DC power supply or an AC power supply. The wireless transmitter 1305 is configured to magnetically attach to a wireless receiver portion on a heated garment (e.g., via complementary magnetic elements) in order to supply a voltage to the energy storage element of the heated garment. The magnetic attachment enables versatility in the positioning of the heated garment when it is to be charged. In some embodiments, a person may be wearing the heated garment and be receiving charge from the wireless transmitter 1305 while the person is in the range of the retractable cord 1315.

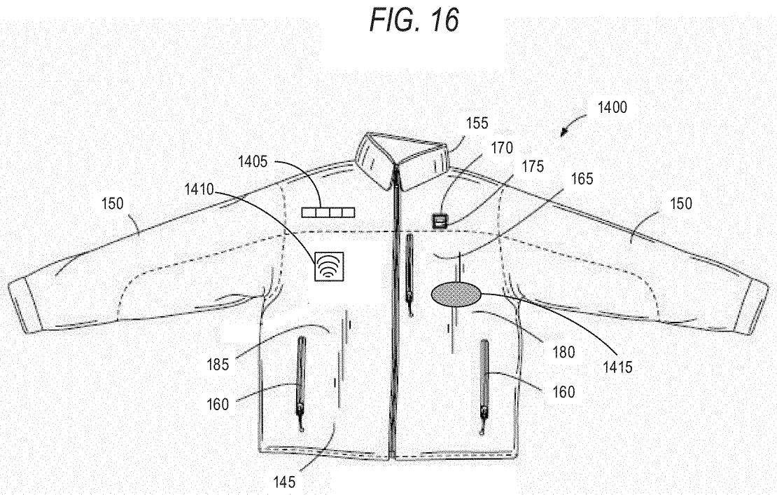

FIG. 16 illustrates an embodiment of a heated garment 1400 that is wirelessly charged or powered. The heated garment 1400 of FIG. 16 is configured to provide heat to a person wearing the garment, as well as indicate parameters on the heated garment 1400 to the person. The particular heated garment 1400 illustrated and provided herein (e.g., a heated jacket) is merely representative. Other embodiments may include a variety of garments. Garments can include, jackets, sweatshirts, hoodies, vests, pants, bibs, socks, shoes, gloves, hats, scarves, and the like.

The heated garment 1400 of FIG. 16 is a front view of the heated jacket. The heated garment 1400 includes typical garment features such as a torso body 145, arms 150, a collar 155, and front pockets 160. A front surface 165 of the garment 1400 includes a control input. In the illustrated embodiment, the control input is a button 170 that may be actuated by a user.

The button 170 includes a display portion 175 to indicate an ON/OFF status of the heated garment 1400. The heated garment 1400 may also include a visual charge indicator 1405, a device charge indicator 1410, and an audible transducer charge indicator 1415. The visual charge indicator 1405 is configured to indicate a charge status of an energy storage element within the heated garment 1400. In some embodiments, the visual charge indicator 1405 may be a rectangle of LEDs broken into segments, each segment indicating a level of charge within the energy storage element. For example, if two of four segments are illuminated, the energy storage element contains 50% charge. In some embodiments, the visual charge indicator 1405 may include colored LEDs. For example, the rectangle of LEDs may be broken into three segments, one segment green, one segment yellow, and one segment red. Each color-coded segment corresponds to a charge level of the energy storage element.

The device charge indicator 1410 is configured to indicate the charge status of a device being charged by the heated garment 1400. For example, the device may be a mobile phone, headphones, a flashlight, and the like. In some embodiments, the device charge indicator may be parallel curved lines made of LEDs, each line indicating a level of charge of the device. For example, if two of the five lines are illuminated then the device has 40% charge.

The audible transducer charge indicator 1415 is configured to indicate the charge status of the energy storage element of the heated garment 1400 and/or the device. In some embodiments, the audible transducer charge indicator 1415 emits a beeping sound at a first frequency when the energy storage element of the heated garment 1400 and/or the device is fully charged. In some embodiments, the audible transducer charge indicator 1415 emits a beeping sound at a second frequency when the energy storage element of the heated garment 1400 and/or the device is less than 20% charged. In some embodiments, the audible transducer charge indicator 1415 emits a beeping sound at a third frequency when the energy storage element of the heated garment 1400 and/or the device is without any charge.

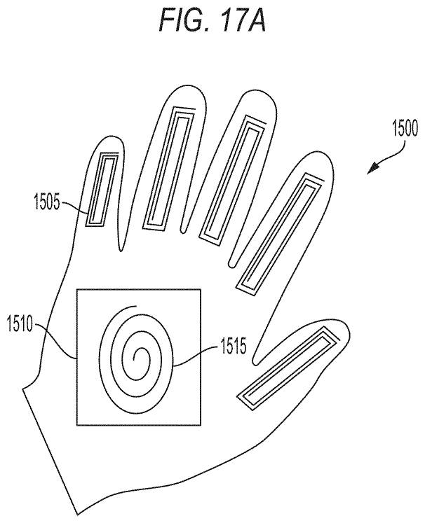

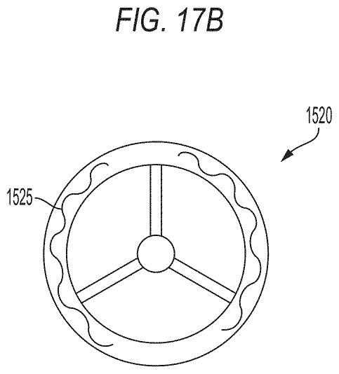

FIG. 17A illustrates a heated garment 1500 that is wirelessly charged or powered. The particular heated garment 1500 illustrated and provided herein (e.g., a heated glove) is merely representative. Other embodiments may include a variety of garments. Garments can include, mittens, fingerless gloves, long sleeve shirts with thumb-holes, and the like.

The heated garment 1500 illustrated in FIG. 17A is a heated glove. The heated garment 1500 includes a wireless receiver 1510 and a receiving coil 1515. As shown in the finger portions of the heated garment 1500, the heated garment 1500 also includes a heater array 1505. The heater array 1505 may be configured to generate heat based on a received DC voltage. For example, heat may be generated by voltage produced by a heated steering wheel, as described with respect to FIG. 17B. The heater array 1505 may be a resistive heater array. However, other heater arrays are also contemplated. The heater array 1505 may include resistive heating coils formed of carbon fibers, high density carbon fibers, or other heating devices. In some embodiments, the heated garment 1500 is capable of maintaining a temperature of up to 110 degrees Fahrenheit, although in other embodiments, lower or greater temperatures are possible depending upon the heat source or user selection (e.g., high, medium, low heat).

The wireless receiver 1510 may be located in the palm area of the heated garment 1500. However, other locations of the wireless receiver 1510 are also contemplated. The receiving coil 1515 is configured to align with a transmitting coil of the steering wheel to allow for inductive and/or magnetic resonance power transfer via a magnetic field. As another example of wireless power transfer, the wireless receiver 1510 may include a receiving antenna configured to allow for RF power transfer from a transmitting antenna of the steering wheel to the heater array 1505 when the wireless receiver 1510 is receiving power from a transmitter within the steering wheel.

The steering wheel 1520 that transmits power to the heated garment 1500 is illustrated in FIG. 17b. The steering wheel 1520 includes a wireless transmitter 1525. The steering wheel 1520 may be wired to receive power that is transmitted to the heated garment 1500 from a vehicle battery. In some embodiments, the steering wheel may be a steering wheel cover that plugs into a vehicle outlet. The steering wheel 1520 may include an AC/DC converter that converts AC power into DC power that is usable by the wireless transmitter 1525. Alternatively, the steering wheel 1520 may transmit the AC power to the wireless transmitter 1525, such that the magnetic field created by the wireless transmitter 1525 is cyclical in nature. In some embodiments, the wireless transmitter 1525 powers the heater array 1505 of the heated garment 1500 when a person wearing the heated garment 1500 is clutching the steering wheel 1520.

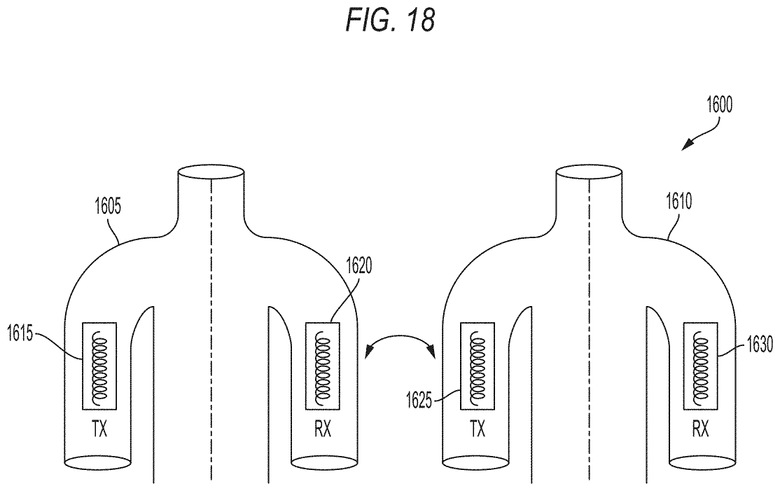

FIG. 18 illustrates a power transfer system 1600 between a first wirelessly charged or powered heated garment 1605 and a second wirelessly charged or powered heated garment 1610. The first heated garment 1605 and the second heated garment 1610 are configured to provide heat, via a first heater array and a second heater array (e.g., similar to heater array 115), respectively, to users wearing the heated garments 1605, 1610. The particular heated garments 1605, 1610 illustrated and provided herein (e.g., heated jackets) are merely representative. Other embodiments may include a variety of garments. Garments can include, jackets, sweatshirts, hoodies, vests, pants, bibs, socks, shoes, gloves, hats, scarves, and the like. In some embodiments, the heated garments 1605, 1610 may not be the same garment.

The first heated garment 1605 includes wireless transmitter 1615 and wireless receiver 1620. In some embodiments, they are instead wireless transceivers 1615 and 1620 that are capable of both transmitting and receiving wireless power. Wireless transmitter 1615 is located on one sleeve on the first heated garment 1605 and wireless receiver 1620 is located on the other sleeve of the first heated garment 1605. The first heated garment 1605 includes a first energy storage element that stores power to be provided to the first heater array. The second heated garment 1610 includes wireless transmitter 1625 and wireless receiver 1630. In some embodiments, they are instead wireless transceivers 1625 and 1630 that are capable of both transmitting and receiving wireless power. Wireless transmitter 1625 is located on one sleeve on the second heated garment 1610 and wireless receiver 1630 is located on the other sleeve of the second heated garment 1610. The second heated garment 1610 includes a second energy storage element that stores power to be provided to the second heater array.

In some embodiments, wireless transmitter 1625 is configured to wirelessly transmit power from the second energy storage element to the first energy storage element, via wireless receiver 1620. In some embodiments, the wireless transmitter 1615 is configured to wirelessly transmit power from the first energy storage element to the second energy storage element, via wireless receiver 1630.

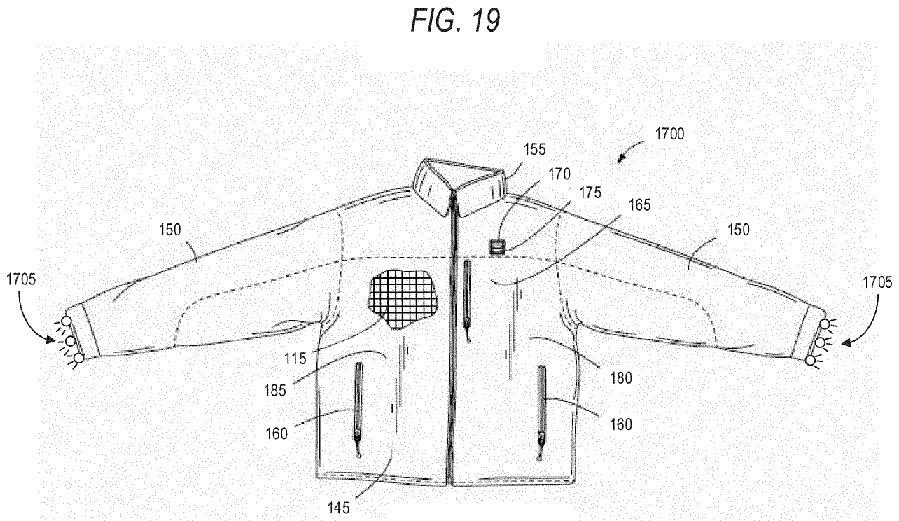

FIG. 19 illustrates an embodiment of a heated garment 1700 that includes illumination members 1705. The heated garment 1700 is configured to provide heat, via a heater array 115, to a person wearing the heated garment 1700. The particular heated garment 1700 illustrated and provided herein (e.g., a heated jacket) is merely representative. Other embodiments may include a variety of garments. Garments can include, jackets, sweatshirts, hoodies, vests, pants, bibs, socks, shoes, gloves, hats, scarves, and the like.

As illustrated in a cutaway portion, the heated garment 1700 also includes the heater array 115. The heater array 115 is powered via power stored in an energy storage device within the heated garment 1700. For example, the heated garment 1700 may include a battery pack within the heated garment 1700. The heated garment 1700 is configured to receive wireless power from a power supply as provided by any of the embodiments described herein.

The heater array 115 is disposed throughout the heated garment 1700. In some embodiments, the heater array 115 may extend into the arms and/or the collar of the heated garment 1700. The heater array 115 may be configured to generate heat based on a received DC voltage. For example, heat may be generated by voltage produced by the energy storage element. The heater array 115 may be a resistive heater array. However, other heater arrays are also contemplated. The heater array 115 may include resistive heating coils formed of carbon fibers, high density carbon fibers, or other heating devices. In some embodiments, the heated garment 1700 is capable of maintaining a temperature of up to 110 degrees Fahrenheit, although in other embodiments, lower or greater temperatures are possible depending upon the heat source or user selection (e.g., high, medium, low heat).

Additionally, the heated garment 1700 includes typical garment features such as a torso body 145, arms 150, a collar 155, and front pockets 160. A front surface 165 of the jacket 10 includes a control input. In the illustrated embodiment, the control input is a button 170 that may be actuated by a user. As explained in greater detail below, the button 170 includes a display portion 175 to indicate a status of the heated garment 1700.

The illumination members 1705 are located on the ends of the arms 150. The illumination members 1705 may include one or more LEDs. The illumination members 1705 are powered by the energy storage element. In some embodiments, the heated garment 1700 includes a switch for actuating the illumination members 1705. In some embodiments, the illumination members 1705 are powered directly from the wireless power received by the heated garment 1700.

Thus, embodiments described herein provide, among other things, wirelessly charged or powered heated garments. Various features and advantages are set forth in the following claims.

What is claimed is:

1. A system for wirelessly charging wearable gear, the system comprising:
a garment body;
a heater coupled to the garment body;
a receiver coupled to the garment body and configured to wirelessly receive power;
an energy storage element coupled to the garment body and configured to store charge provided to the receiver;
a controller configured to selectively provide power from the energy storage element to the heater; and
a power supply including a transmitter configured to wirelessly provide power to the receiver when the transmitter is near the receiver.

2. The system of claim 1, wherein the power supply is portable and is configured to be coupled to a seat.

3. The system of claim 1, further comprising:
a first wireless charging element coupled to the garment body at a first location in the garment body and including a second transmitter configured to selectively receive power from the energy storage element and to wirelessly charge a device when the device is near the second transmitter.

4. The system of claim 1, further comprising:
a first wireless charging element coupled to the garment body at a first location in the garment body and including a second transmitter configured to selectively receive power from the energy storage element and to wirelessly charge a head covering including a head covering receiver when the head covering receiver is near the second transmitter.

5. They system of claim 4, wherein the head covering includes an illumination member that is configured to be illuminated based on power received from the first wireless charging element.

6. The system of claim 1, further comprising:
an external power device received by the garment body including a second transmitter and configured to wirelessly provide power to the receiver when coupled to the garment body.

7. The system of claim 1, further comprising:
an AC power source coupled to a second transmitter and configured to wirelessly provide power to the receiver when the second transmitter is near the receiver to heat the garment body.

8. The system of claim 1, further comprising:
a second receiver coupled to the garment body at a first location in the garment body; and
a second power supply including a second transmitter configured to wirelessly provide power to the second receiver when the second transmitter is near the second receiver.

9. The system of claim 1, further comprising:
a second garment body;
a second heater coupled to the second garment body;
a second receiver coupled to the second garment body and configured to wirelessly receive power;
a second energy storage element coupled to the second garment body and configured to store charge provided to the second receiver;
a second controller selectively providing power from the second energy storage element to the second heater; and
a wireless charging element coupled to the second garment body at a first location in the second garment body and configured to selectively receive power from the second energy storage element and to wirelessly charge the energy storage element of the garment body.

10. The system of claim 1, wherein the power supply includes a magnet fixed to the transmitter and configured to magnetically attach to the receiver.

11. The system of claim 1, wherein the garment body is worn on a hand of a user and the power supply is a steering wheel of a vehicle.

12. A heated garment comprising:
a garment body;
a heater coupled to the garment body;
a receiver coupled to the garment body and configured to wirelessly receive power;
an energy storage element coupled to the garment body and configured to store charge provided to the receiver; and
a controller configured to selectively provide power from the energy storage element to the heater.

13. The heated garment of claim 12, further comprising:
a wireless charging element coupled to the garment body at a first location in the garment body and including a second transmitter configured to selectively receive power from the energy storage element and to wirelessly charge an electronic device when the electronic device is near the second transmitter.

14. The heated garment of claim 13, further comprising:
a visual indicator configured to indicate a charge level of the electronic device.

15. The heated garment of claim 12, further comprising:
a visual indicator configured to indicate a charge level of the energy storage element.

16. The heated garment of claim 12, further comprising:
an audible transducer configured to indicate a charge level of the energy storage element.

17. The heated garment of claim 12, further comprising:
one or more light emitting diodes (“LEDs”) coupled to the garment body and configured to be selectively illuminated by the controller.

18. A heated garment comprising:
a garment body;
a heater coupled to the garment body;
a receiver coupled to the garment body and configured to wirelessly receive power;
an energy storage element coupled to the garment body and configured to store charge provided to the receiver;
a transmitter coupled to the garment body and configured to wirelessly transmit power from the energy storage element to a device; and
a controller configured to:
selectively provide power from the energy storage element to the heater, and
selectively provide power from the energy storage element to the transmitter.

19. The heated garment of claim 18, wherein the garment body is worn on the hand of a user and the device is a flashlight.

20. The heated garment of claim 18, wherein the device is a second receiver coupled to a second garment body, and wherein the second garment body includes a heater that receives power from the energy storage element via the second receiver.
